(19) United States
(12) Patent Application Publication
(10) Pub. No.: US 2026/0145987 A1
(43) Pub. Date: May 28, 2026

(54) SYSTEM AND METHOD FOR FABRICATION OF HOLLOW-CORE FIBERS

(71) Applicant: Relativity Networks, Inc., Winter Park, FL (US)

(72) Inventors: Jason M. EICHENHOLZ, Orlando, FL (US); Rodrigo AMEZCUA CORREA, Orlando, FL (US)

(21) Appl. No.: 19/402,154

(22) Filed: Nov. 26, 2025

Related U.S. Application Data
(60) Provisional application No. 63/726,224, filed on Nov. 27, 2024.

(51) Int. Cl. C03B 37/022; C03B 37/03; C03B 37/07; G02B 6/032

(52) U.S. Cl. CPC C03B 37/022; C03B 37/032; C03B 37/07; G02B 6/032; C03B 2203/16; C03B 2205/40; C03B 2205/60

(57) ABSTRACT

A system configured to fabricate an optical fiber is disclosed. The system may include at least one draw furnace configured to heat a preform, and draw an optical fiber from the preform. The optical fiber may be a hollow-core fiber having a core and one or more anti-resonant elements. The system may be configured to draw the optical fiber at a desired draw tension. The desired draw tension may be greater than 1,000 grams.

### CROSS-REFERENCE TO RELATED APPLICATION

The present application claims the benefit of U.S. Provisional Patent Application 63/726,224 filed on Nov. 27, 2024, which is incorporated herein by reference in its entirety.

### BACKGROUND OF THE INVENTION

Hollow-core fibers (HCF) are optical fibers that guide light primarily through air. HCF offers various benefits over traditional glass core fibers including, but not limited to, high average and peak power capability, high damage thresholds, low latency, low non-linearities, etc. However, it is known that fabricating hollow-core fibers is more challenging than fabricating traditional glass core fibers, particularly needed to achieve good geometrical structure and low attenuation. Thus, there exists a need for a system and method to overcome the challenges in fabricating hollow-core fibers.

### BRIEF DESCRIPTION OF THE DRAWINGS

Various embodiments of the invention are disclosed in the following detailed description and the accompanying drawings.

FIG. 1 is a block diagram of a single-stage draw tower in accordance with one or more embodiments of the present disclosure.

FIG. 2 is a block diagram of a multi-stage draw tower in accordance with one or more embodiments of the present disclosure.

FIG. 3 is a schematic diagram of a multi-stage draw tower with three-stages in accordance with one or more embodiments of the present disclosure.

FIG. 4A depicts a first example cross-sectional view of an anti-resonant hollow-core fiber design in accordance with one or more embodiments of the present disclosure.

FIG. 4B depicts a second example cross-sectional view of an anti-resonant hollow-core fiber design in accordance with one or more embodiments of the present disclosure.

FIG. 5 is a flow diagram of a method to fabricate an optical fiber in accordance with one or more embodiments of the present disclosure.

### SUMMARY

A system to fabricate an optical fiber is disclosed in accordance with one or more illustrative embodiments. In some embodiments, the system may include a single-stage draw tower that may include a draw furnace configured to heat a preform and draw the optical fiber from the preform. The system may be configured to draw the optical fiber at a desired draw tension. The desired draw tension may be greater than 1,000 grams. In some embodiments, the desired draw tension may be greater than 1,500 grams.

In some embodiments, the optical fiber may be a hollow-core optical fiber that may include a core and one or more anti-resonant elements.

In some embodiments, the system may further include a pressure unit/system configured to apply pressure to the preform.

The system may further include a puller configured to draw the optical fiber at a desired draw speed from the draw furnace. The system may additionally include a monitoring unit/system configured to monitor parameters of the preform during a draw process. The parameters may include, but are not limited to, a diameter, a temperature, a draw speed, a tension, a geometry, and/or the like of the preform.

The system may further include a controller configured to obtain inputs from the monitoring system, and control a furnace temperature associated with the draw furnace and/or a draw speed associated with the puller to achieve or maintain the desired draw tension. In certain embodiments, the controller may be additionally configured to control an operation of the puller to draw the optical fiber at a desired diameter based on the inputs obtained from the monitoring system.

In alternative embodiments, the system may include a multi-stage draw tower that may include or support a plurality of draw stages. The multi-stage draw tower may include a plurality of draw furnaces associated with the plurality of draw stages. The plurality of draw furnaces may be configured to progressively decrease a diameter of a preform to form an optical fiber of a desired diameter in a single draw process. Similar to the embodiment involving the single-stage draw tower, the multi-stage draw tower may also be configured to draw the optical fiber at a desired draw tension, which may be greater than 1,000 grams. In a preferred embodiment, the desired draw tension may be greater than 1,500 grams.

In some embodiments, the plurality of draw stages in the multi-stage draw tower may include a first draw stage at a highest vertical position, and successive draw stages below the highest vertical position. In certain embodiments, the system may be configured to draw the optical fiber at the desired draw tension at the first draw stage. In additional embodiments, the system may be configured to draw the optical fiber at the desired draw tension at the first draw stage and one or more successive draw stages.

In some embodiments, the system including the multi-stage draw tower may also include a pressure unit/system configured to apply pressure to the preform prior to the first draw stage. In further embodiments, the system may further include one or more pullers configured to draw the optical fiber through the plurality of draw stages.

In some embodiments, an optical fiber drawn from a system including a single-stage draw tower or a multi-stage draw tower is disclosed. The optical fiber may be a hollow-core fiber. The system may be configured to draw the optical fiber at a desired draw tension that may be greater than 1,000 grams, and preferably greater than 1,500 grams.

### DETAILED DESCRIPTION

The invention can be implemented in numerous ways, including as a process; an apparatus; a system; a combination of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘process’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of the present disclosure are directed to systems and methods for fabricating hollow-core optical fibers (HCFs) by applying a high draw tension. In some embodiments, the HCF may be formed by applying a draw tension greater than 1,000 grams to a preform. In a preferred embodiment, the HCF may be formed by applying a draw tension greater than 1,500 grams to the preform. In certain embodiments, the HCF may be fabricated in a single draw stage by using a single-stage draw tower. In other embodiments, the HCF may be fabricated in multiple draw stages by using a multi-stage draw tower.

In some embodiments, the single-stage draw tower may include one or a single draw furnace that may be configured to heat the preform. The single-stage draw tower may be configured to draw an optical fiber (i.e., the HCF) from the preform in a single stage. In some aspects, the optical fiber may be drawn directly from the preform in a single draw process. In other aspects, a preform may be a result of an intermediate step and may be referred to as a cane. As an illustration, a relatively large preform may be drawn down to one or more canes with an intermediate diameter. These canes may generally have any length. These canes may then be used as a preform for a subsequent draw to produce HCFs at desired diameters by applying a draw tension of greater than 1,000 grams, (preferably greater than 1,500 grams) at this stage. The use of a single draw stage enables precise control of various parameters of the preform or the optical fiber including, but not limited to, tension, pressure, draw speed, cladding diameter, temperature, etc.

In alternative embodiments, the multi-stage draw tower may include a plurality of draw furnaces at a plurality of draw stages, where each draw stage may include a separate draw furnace. The multi-stage draw tower may be configured to progressively reduce the diameter of the preform to draw the optical fiber at the desired diameter. In some aspects, the multi-stage draw tower may be configured to apply a high draw tension at the first stage. The high draw tension is this case may also be greater than 1,000 grams, preferably greater than 1,500 grams.

In another embodiment, the multi-stage draw tower may be configured to apply the high draw tension at subsequent stages as well (e.g., at the second stage and/or the third stage). The use of multiple stages in a single-draw process may enable precise control over various parameters of the preform at each stage including, but not limited to, a draw-down ratio (e.g., a ratio of the diameter of the optical fiber before and after a particular stage), tension, pressure, draw speed, diameter, temperature, etc.

In some aspects, the system may include a pressure unit/system that may be configured to apply pressure to the preform. The pressure system may be located on a top end of the single-stage draw tower or the multi-stage draw tower. In an exemplary embodiment, the pressure applied in the multi-stage draw tower may be greater than the pressure applied in the single-stage draw tower. The pressure applied depends on the scaling ratio and the drawing parameters. Typically, the smaller the fiber produced, the higher the pressure. The pressure will depend on the final fiber structure. Typical pressures range between 10-1000 mbar gauge pressure. Further when drawing at high tension, coating integrity may be compromised. Thus, it is important to match coating parameters to be compatible with the high tension draw process.

The present disclosure is directed towards a system and method that fabricates an HCF at a high draw tension, which enables better control of the anti-resonant element geometry and therefore improves the yield of the HCF from a draw. A person ordinarily skilled in the art may appreciate that HCF preforms may be more susceptible to collapsing/expanding/over inflation during the drawing process, which may limit the yield of HCF during a draw, which may in turn limit high-volume manufacturing. In addition, a person ordinarily skilled in the art may appreciate that during the HCF drawing process, Mid-draw contact (MDC) phenomenon occurs. Such phenomenon may adversely affect the optical properties of the HCF. The MDC phenomenon may occur when the capillaries in the fiber contact each other during the drawing process, due to interplay between surface tension and gas pressure.

To avoid the occurrence of MDC during the fiber draw, one way is to increase the draw tension (that makes the glass stiffer and hence less sensitive to pressure) and a second way is to reduce the size of the preform and hence a strain rate, to achieve better anti-resonant element geometry (e.g., to draw thinner anti-resonant elements). To maintain a constant draw tension, the increase in the strain rate must be balanced by increasing the furnace temperature, which decreases the glass'viscosity, making the capillaries more sensitive to the applied pressure at the start of the neckdown and increasing the likelihood of MDC. Thus, in such cases, to avoid the occurrence of MDC during the fiber draw, the draw tension needs to be increased. When the HCF is fabricated according to the present disclosure, i.e., with a high draw tension greater than 1,000 grams (preferably greater than 1,500 grams), better control of the anti-resonant element geometry is achieved, which considerably improves the yield of the HCF from the draw. The draw tension is a force that is applied to a preform or optical fiber along the direction in which the fiber is drawn and may be expressed in associated units of force (e.g., newtons, or N). Herein, draw tension is expressed as a mass (e.g., in units of grams), where the corresponding tension is equivalent to the weight of that mass under the pull of Earth's gravity (approximately 9.81 m/s²). For example, a tension expressed herein as 1,000 grams corresponds to a force (or, equivalently, a weight) of approximately 9.8 N, and a tension expressed as 1,500 grams corresponds to a force of approximately 14.7 N.

It is further contemplated herein that the systems and methods disclosed herein may be suitable for any HCF design. Further, the precise geometry control provided by the systems and methods disclosed herein may enable the fabrication of more fragile fiber designs (e.g., those more prone to collapse) than existing techniques.

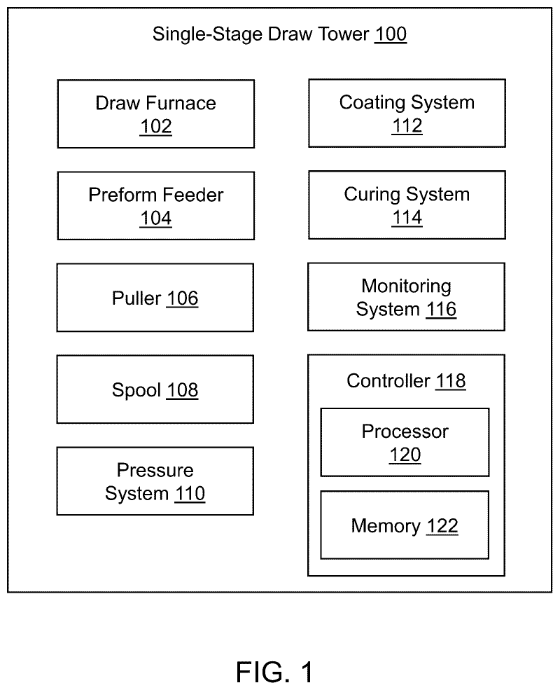

Turing now to the figures, FIG. 1 is a block diagram of a single-stage draw tower 100 in accordance with one or more embodiments of the present disclosure. The single-stage draw tower 100 may be configured to fabricate an optical fiber at a high draw tension (or a desired draw tension). In some aspects, the desired draw tension may be greater than 1,000 grams. In further aspects, the desired draw tension may be greater than 1,500 grams. Additionally, the desired draw tension may be less than 3,000 grams. In some aspects, the optical fiber may be a hollow core-fiber (HCF). The HCF may include a hollow core and one or more anti-resonant elements. It is known that in anti-resonant HCFs, light is guided in the hollow core as a result of anti-resonant properties of thin walled structures extending along the length of the fiber.

In an exemplary embodiment, the single-stage draw tower 100 may be a vertical drawing system that may be used to vertically draw the optical fiber from a preform in a downward direction. The preform may be a cylindrical rod having an initial diameter (or a “current diameter”) that may be many times a final diameter (or a “desired diameter”) of the optical fiber. The preform may be fabricated to have the same or similar cross-section as the desired optical fiber. It is to be understood that the optical fiber may be formed from the preform by a drawing process. Accordingly, the preform and the optical fiber may have the same or substantially similar compositions.

The single-stage draw tower 100 may be configured to draw material from the preform in a new form with a smaller diameter than the preform, in a single stage. In some aspects, the resultant of the draw process of the single stage may be the optical fiber having the desired diameter (or the final diameter) that may be of the order of tens or hundreds of micrometer. Stated another way, the single-stage draw tower 100 may produce the optical fiber from the preform directly in a single draw process, by applying a high draw tension of 1,000 grams (preferably greater than 1,500 grams).

In other aspects, the resultant of a single stage of the draw process may be one or more intermediate preforms (which are often referred to as “canes”) having an intermediate diameter that may be smaller than the preform's original diameter but larger than the final diameter. The intermediate diameter may be of the order of a few millimeters to a few centimeters. These intermediate preforms (e.g., canes) may generally have any length, but are approximately 1-5 meters in some cases. The intermediate preform may then be subsequently drawn using the draw process to form the optical fiber having the desired diameter by applying a high draw tension of 1,000 grams (preferably greater than 1,500 grams) at this stage.

In an exemplary embodiment, the single-stage draw tower 100 may include a plurality of components including, but not limited to, a draw furnace 102, a preform feeder 104, a puller 106, a spool 108, a pressure system 110, a coating system 112, a curing system 114, a monitoring system 116, a controller 118, and/or the like, as shown in FIG. 1.

The single-stage draw tower 100 may include one or a single draw furnace (i.e., the draw furnace 102) that may be configured to heat a preform to a high temperature (e.g., above 1,900° C.) to draw the optical fiber from the preform, in a single stage. The draw furnace 102 may be located in proximity to a top end of the single-stage draw tower 100. Thus, the draw furnace 102 may heat the preform at the top end of the single-stage draw tower 100. The draw furnace 102 may heat a lower tip of the preform to soften the lower tip of the preform. Once the softening point of the preform tip is reached, gravity takes over and allows a molten gob to “free fall”, allowing the drawing of the optical fiber of the desired diameter. Thus, the draw furnace 102 may be used to reduce a current or original diameter of the preform to the desired diameter, to form the optical fiber.

The draw furnace 102 may include any component or a combination of components suitable for heating the preform. In some aspects, the draw furnace 102 may include heating elements that may heat the preform. The heating elements may include, but are not limited to, radiative heating elements, conductive heating elements, inductive heating elements, and/or the like. The draw furnace 102 may be configured to control a temperature of the preform to facilitate the drawing of the optical fiber at the desired draw tension and/or a desired draw speed. In some aspects, the draw furnace 102 may be configured to control the preform's temperature to draw the optical fiber from the preform such that optical fiber is drawn at the desired draw tension.

The preform feeder 104 may be configured to feed the preform into the draw furnace 102. The preform feeder 104 may include any component or a combination of components suitable for feeding the preform. In some aspects, the preform feeder 104 may include components to secure the preform such as, but not limited to, holders, clips, springs, and/or the like. In further aspects, the preform feeder 104 may include components (e.g., x-y positioning systems) configured to position the preform and/or lower the preform into the draw furnace 102. In certain embodiments, the preform feeder 104 may feed the preform to the draw furnace 102 at a preform feed rate that may be based on the draw speed, the preform diameter (or current or original diameter of the preform), and the desired diameter of the optical fiber.

The puller 106 may be configured to pull the optical fiber from the draw furnace 102. The puller 106 may include any component or a combination of components suitable for pulling the optical fiber from the draw furnace 102. In some aspects, the puller 106 may include one or more belts and one or more wheels. The puller 106 may be configured to control a draw speed and/or tension of the preform, and facilitate the drawing of the optical fiber at the desired draw speed and/or the desired draw tension (which may be, for example, greater than 1,000 grams, preferably greater than 1,500 grams). The pulled optical fiber may then be wound on the spool 108. The spool 108 may be configured to collect and store the optical fiber, as the optical fiber is drawn by the puller 106.

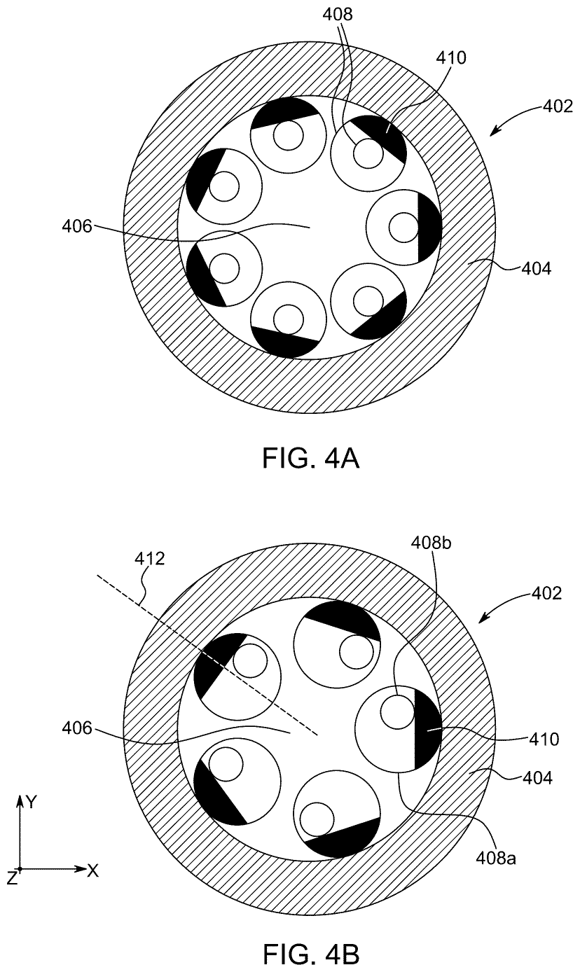

The pressure system 110 may be configured to apply pressure to the preform. The pressure system 110 may include any component or a combination of components suitable for applying pressure to the preform. In some aspects, the pressure system 110 may be located at a top of the single-stage draw tower 100, and may pressurize the preform from the top of the single-stage draw tower 100 to pressurize the core and the anti-resonant elements. In some aspects, the pressure system 110 may be configured to apply a high pressure to the preform. In an exemplary embodiment, the pressure system 110 may fill gas within one or more hollow regions of the preform, such as within the anti-resonant (AR) elements (shown as AR elements 408 FIGS. 4A and 4B) and hollow interior region (shown as hollow interior region 406 in FIGS. 4A and 4B) of the preform. As an example, the pressure system 110 may fill nitrogen, argon, or any inert gas in the hollow regions of the preform. In some aspects, the pressure system 110 may fill ambient atmosphere in the hollow regions of the preform.

The coating system 112 may be configured to apply one or more coatings on the optical fiber after the optical fiber has reached the desired diameter. The coating system 112 may include any component or a combination of components suitable for coating the preform. Further, the coating system 112 may apply coating(s) of any material. For example, the coating system 112 may include one or more containers with a coating fluid (e.g., a polymer, an acrylate, or any suitable compound) through which the fiber may pass. When the fiber passes through the containers, the coating fluid may surround the fiber, thereby enabling the coating of the fiber. In some aspects, the optical fiber may be cooled down to a temperature below 100° C. (as an example), and then provided with the coating(s). The coating(s) may be of any thickness. The coating(s) may be applied by using a single coating applicator or multiple coating applicators.

The curing system 114 may be configured to cure the coatings applied on the optical fiber. The curing system 114 may include any component or a combination of components suitable for curing the coatings. For example, the curing system 114 may include light sources or heat sources to cure the coating. In an exemplary embodiment, the curing system 114 may include ultra-violet (UV) light sources to cure the coating.

The monitoring system 116 may be configured to monitor the efficiency and operational status of the components of the single-stage draw tower 100, and monitor one or more parameters of the preform or the optical fiber during the draw process. For example, the monitoring system 116 may monitor the efficiency and operational status of the draw furnace 102, the puller 106, the spool 108, the pressure system 110, the coating system 112, the curing system 114, etc., and monitor parameters of the preform or the optical fiber including, but not limited to, a diameter, a draw speed, temperature, draw tension, pressure, and/or the like.

The monitoring system 116 may include a plurality of sensors configured to monitor the parameters described above. In some aspects, the plurality of sensors may include one or more diameter sensors that may be configured to monitor the diameter of the preform or the optical fiber at any point of the draw process. In some aspects, the diameter sensors may include laser-based diameter gauges that may monitor the diameter of the preform/optical fiber. The sensors may further include one or more speed sensors configured to monitor the draw speed of the preform at any point of the draw process. The sensors may further include one or more temperature sensors configured to monitor temperature of the preform at any point of the draw process. The sensors may further include tension sensors that may be configured to monitor the draw tension of the preform at any point of the draw process. The sensors may additionally include pressure sensors configured to monitor the pressure applied to the preform. The sensors may further include coating sensors to monitor the coating(s) applied to the optical fiber by the coating system 112 and/or the curing system 114.

The controller 118 may be communicatively coupled to one or more components of the single-stage draw tower 100 described above. For example, the controller 118 may be communicatively coupled to the monitoring system 116, the pressure system 110, the preform feeder 104, the draw furnace 102, etc. In further aspects, the controller 118 may be communicatively coupled to a user interface (not shown). The user interface may be configured to obtain user inputs (e.g., inputs associated with the desired diameter of the optical fiber and/or the desired draw tension). The controller 118 may include one or more processors 120 configured to execute a set of program instructions maintained in a memory 122. The processors 120 may include any microprocessor-type device configured to execute algorithms and/or instructions. The processors 120 may include one or more processing or logic elements (e.g., one or more micro-processor devices, one or more application specific integrated circuit (ASIC) devices, one or more field programmable gate arrays (FPGAs), or one or more digital signal processors (DSPs)).

In some embodiments, the processors 120 are formed as or integrated within a desktop computer, mainframe computer system, workstation, image computer, parallel processor, networked computer, or any other computer system configured to execute program instructions. Further, the steps described throughout the present disclosure may be carried out by a single controller or, alternatively, multiple controllers. Additionally, the controller 118 may include one or more controllers housed in a common housing or within multiple housings.

The memory 122 may include any storage medium known in the art suitable for storing program instructions executable by the associated processors 120. For example, the memory 122 may include a non-transitory memory medium. By way of another example, the memory 122 may include, but is not limited to, a read-only memory (ROM), a random-access memory (RAM), a magnetic or optical memory device (e.g., disk), a magnetic tape, a solid-state drive and the like. It is further noted that the memory 122 may be housed in a common controller housing with the processors 120. In some embodiments, the memory 122 may be located remotely with respect to the physical location of the processors 120 and the controller 118. For instance, the processors 120 of the controller 118 may access a remote memory (e.g., server), accessible through a network (e.g., internet, intranet and the like).

In some aspects, the controller 118 may receive inputs from the monitoring system 116, and control the draw parameters to improve the quality of the optical fiber. Specifically, the controller 118 may generate control signals based on the inputs obtained from the monitoring system 116, and control the draw parameters by transmitting the control signals to one or more components of the single-stage draw tower 100 to control their operations, thereby improving the quality of the produced optical fiber.

In some aspects, the controller 118 may control the preform's draw tension, pressure, draw speed, diameter, and/or temperature (including furnace temperature) based on the inputs obtained from the monitoring system 116. In an exemplary aspect, the controller 118 may obtain inputs from the diameter sensor(s), and may control/adjust the draw speed associated with the puller 106 based on the inputs obtained from the diameter sensor(s). As an example, when the fiber diameter increases above a threshold (e.g., a “first” threshold), the controller 118 may increase the drawing speed, and when the fiber diameter decreases below the first threshold, the controller 118 may decrease the drawing speed to draw the optical fiber at the desired diameter. Similarly, the controller 118 may obtain inputs from the tension sensor, and may adjust the temperature of the draw furnace 102 based on the obtained inputs. When the draw tension decreases below a threshold (e.g., a “second” threshold), the controller 118 may decrease the temperature of the draw furnace 102 to increase the draw tension, thereby maintaining the desired draw tension. In some aspects, the controller 118 may control the operation of the draw furnace 102 (e.g., the temperature of the draw furnace 102) and/or operation of other components of the single-stage draw tower 100 (e.g., the puller 106) such that the draw tension is always greater than 1,000 grams, and preferably greater than 1,500 grams.

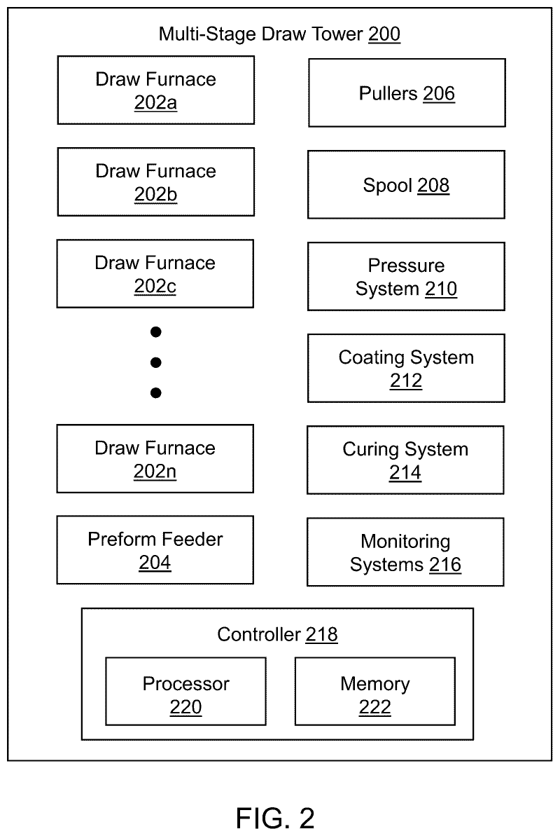

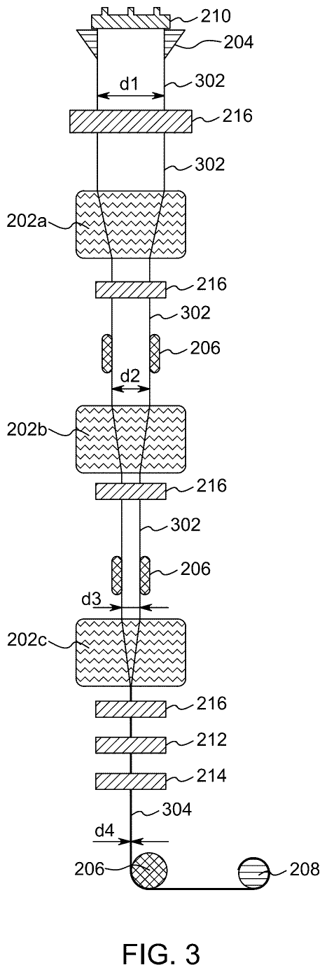

FIG. 2 is a block diagram of a multi-stage draw tower 200 in accordance with one or more embodiments of the present disclosure. FIG. 2 will be explained in conjunction with FIG. 3. The multi-stage draw tower 200 may be configured to fabricate an optical fiber 304 (shown in FIG. 3) at a high draw tension (or a desired draw tension). The multi-stage draw tower 200 may be a vertical drawing system that may be used to vertically draw the optical fiber 304 from a preform 302. In some aspects, the desired draw tension described above may be greater than 1,000 grams. In a preferred embodiment, the desired draw tension may be greater than 1,500 grams. Additionally, the desired draw tension may be less than 3,000 grams. In some aspects, the optical fiber 304 may be a hollow-core optical fiber (HCF). A person ordinarily skilled in the art may appreciate that a hollow-core optical fiber may include a core and one or more anti-resonant elements. Other elements may be found within a draw tower, but are not required. For example, an annealing furnace or a cooling chamber may exist within the draw tower.

The multi-stage draw tower 200 may include a plurality of stages, which may be configured to progressively reduce a diameter of the preform 302 from its initial diameter (e.g., “d1” shown in FIG. 3) to a final diameter (e.g., “d4” shown in FIG. 3) of the optical fiber 304, in a single-draw process. For the purposes of the present disclosure, the term “preform” may be used to refer to the material placed into the multi-stage draw tower 200 that may be progressively drawn through one or more intermediate diameters. Further, the term “optical fiber” may be used to refer to the final material having the desired diameter and may be suitable for guiding light at selected wavelength(s).

In one exemplary embodiment, the multi-stage draw tower 200 may be configured to apply the high draw tension at the first stage and control the geometry of the anti-resonant structures. In another embodiment, the multi-stage draw tower 200 may be configured to apply the high draw tension at one or more subsequent stages as well (e.g., at the second stage and/or the third stage), which may enable a gradual draw-down process and control the fiber geometry.

The multi-stage draw tower 200 may include a plurality of components including but not limited to, a plurality of draw furnaces 202a, 202b, 202c . . . 202n (collectively referred as draw furnaces 202), a preform feeder 204, one or more pullers 206, one or more spools 208, a pressure system 210, a coating system 212, a curing system 214, a monitoring system 216, a controller 218, and/or the like.

The multi-stage draw tower 200 may include the plurality of draw furnaces 202a, 202b . . . 202n (hereinafter referred as draw furnaces 202) for a plurality of draw stages. Each draw stage may include a separate draw furnace. For example, a first draw stage may include the first draw furnace 202a, a second draw stage may include the second draw furnace 202b, a third draw stage may include a third draw furnace, and so on. The plurality of draw furnaces 202a, 202b . . . 202n may be arranged vertically at different heights. For example, the first draw furnace 202a may be located at a highest vertical position in the multi-stage draw tower 200, the second draw furnace 202b may be located below the first draw furnace 202a (or below the highest vertical position), and so on. The plurality of draw furnaces 202a, 202b . . . 202n may be configured to heat the preform 302 at a high temperature. Each draw furnace 202a, 202b . . . 202n may be the same as or similar to the draw furnace 102 described above in conjunction with FIG. 1. In some aspects, the plurality of draw furnaces 202a, 202b . . . 202n may have same or different configuration or operational parameters. For example, different draw furnaces may have different heating profiles that may be based on the desired draw ratio (e.g., a ratio of the diameter of the preform before and after a particular stage).

In some aspects, the first draw furnace 202a of the first stage may heat the preform 302 and reduce a diameter of the preform 302 by a first selected draw ratio (e.g., from a first diameter “d1” or the original diameter of the preform 302 to a second diameter “d2”). The successive draw stages may be configured to heat the preform 302 with the associated furnaces (e.g., the second draw furnace 202b, the third draw furnace 202c, etc.) and successively reduce the diameter of the preform 302 until the optical fiber 304 with the desired diameter (e.g., diameter “d4”) is drawn. For example, the second draw furnace 202b may receive the preform 302 with the second diameter “d2” and reduce the diameter by a second selected draw ratio (e.g., from the second diameter “d2” to a third diameter “d3”). In this manner, the draw stages may progressively draw down the preform 302 into the optical fiber 304 with the desired diameter.

In some aspects, one or more draw furnaces of the plurality of draw furnaces 202 may be configured to control a furnace temperature to draw the optical fiber 304 from the preform 302 by applying a high draw tension that may be greater than 1,000 grams. In a preferred embodiment, the draw tension may be greater than 1,500 grams.

In an exemplary embodiment, the first draw furnace 202a associated with the first stage may be configured to draw the material at the high tension rate (e.g., greater than 1,000 grams or 1,500 grams). Typically, glass fiber is not drawn at tensions more than 100 grams because drawing at tensions above this will often deform, break, or introduce defects into the material. The multi-stage draw tower 200 may be configured to apply the high draw tension at the first stage. In another embodiment, the multi-stage draw tower 200 may be configured to apply the high draw tension at subsequent stages as well (e.g., at the second stage and/or the third stage).

The preform feeder 204 may be configured to feed the preform 302 into the first draw furnace 202. In some aspects, the preform feeder 204 may feed the preform 302 at the top of the multi-stage draw tower 200 (e.g., prior to the first stage). In some aspects, the preform feeder 204 may be the same as or similar to the preform feeder 104 described above in conjunction with FIG. 1.

The pullers 206 may be configured to pull the optical fiber 304 from the plurality of draw furnaces 202a, 202b . . . 202n. In some aspects, one puller may be associated with one draw furnace. For example, a first puller may be configured to pull the preform 302 with the second diameter from the first draw furnace 202a, a second puller may be configured to pull the preform with the third diameter (that may be less than the second diameter) from the second draw furnace 202b, and so on. In other aspects, one puller may be used to draw the optical fiber 304 from the plurality of draw furnaces 202a, 202b . . . 202n.

The pulled optical fiber 304 may then be wound on a spool 208. In some aspects, one spool 208 may be used to wound the optical fiber 304, and may be located at a lowest position in the multi-stage draw tower 200. The spool 208 may be configured to collect and store the optical fiber 304, as the optical fiber 304 is drawn. In other aspects, the multi-stage draw tower 200 may include more than one spool 208. In some aspects, the number of spools 208 in the multi-stage draw tower 200 may be equivalent to the number of pullers 206. The pullers 206 may be the same as or similar to the puller 106, and the spool 208 may be the same as or similar to the spool 108 described above in conjunction with FIG. 1.

The pullers 206 may be configured to control a draw speed or tension of the preform 302/optical fiber 304, and facilitate the drawing of the optical fiber 304 at the desired draw tension and/or the desired draw speed. In an exemplary embodiment, the first puller may pull the preform 302 at the high draw tension (or the desired draw tension). In some aspects, the draw rate associated with any particular draw stage (e.g., a current draw stage) may be selected based on considerations such as, but not limited to, a draw rate provided by a previous draw stage (or the preform feeder 204 in the case of the first draw stage), a temperature of the preform 302 entering the current draw stage, a tension on the preform 302 entering the current draw stage, a temperature of the draw furnace of the current draw stage, the desired draw-down ratio, and/or the like.

The pressure system 210 may be configured to apply pressure to the preform 302 and may be located at a top of the multi-stage draw tower 200 (e.g., above the first draw furnace 202a). The pressure system 210 may be the same as or similar to the pressure system 110 described above in conjunction with FIG. 1. In some aspects, the pressure used in the multi-stage draw tower 200 may be greater than the pressure used in the single-stage draw tower 100. Specifically, in a multi-stage process the pressure applied to the void regions of the core may be higher than in the single-stage process.

The coating system 212 may be configured to apply coating on the optical fiber 304 after the optical fiber 304 has reached the desired diameter (e.g., when the preform 302 passes through the last draw furnace), and the curing system 214 may be configured to cure the coatings applied on the optical fiber 304. The coating system 212 and the curing system 214 may be the same as or similar to the coating system 112 and the curing system 114 described above in conjunction with FIG. 1.

The monitoring system 216 may be configured to monitor the efficiency and operational status of the components of the multi-stage draw tower 200, and monitor one or more parameters of the preform 302 at each stage or one or more parameters of the optical fiber 304. The monitoring system 216 may include sensors that may be the same as or similar to the sensors of the monitoring system 116 described above in conjunction with FIG. 1. In some aspects, the monitoring system 216 may be configured to monitor the diameter of the preform 302 after each stage or the diameter of the optical fiber 304. For example, the monitoring system 216 may monitor the preform diameter when the preform 302 passes through the first draw furnace 202a, and continue to monitor the preform diameter until the optical fiber 304 with the desired diameter is drawn from the preform 302. The monitoring system 216 (or components thereof) may be distributed throughout the multi-stage draw tower 200 in any manner and may optionally be integrated into any of the draw stages.

The controller 218 may be communicatively coupled to one or more components of the multi-stage draw tower 200. The controller 218 may include one or more processors 220 and a memory 222. The controller 218 may be the same as or similar to the controller 118, the processors 220 may be the same as or similar to the processors 120, and the memory 222 may be the same as or similar to the memory 122 described above in conjunction with FIG. 1. In some aspects, the controller 218 may control parameters including, but not limited to, a draw-down ratio (e.g., a ratio of the diameter of the preform 302 before and after a particular stage), a draw tension, pressure, a draw speed, a diameter, a temperature (e.g., furnace temperature), and/or the like associated with the preform 302. In some aspects, the controller 218 may adjust any operating parameters of any of the draw stages and/or components. For example, the controller 118 may dynamically control the draw rates/feed rates/draw tension across all stages to maintain the desired draw ratios, the diameters at each draw stage, and/or the draw tension (which may be greater than 1,000 grams, preferably greater than 1,500 grams).

The single-stage draw tower 100 or the multi-stage draw tower 200 described above in conjunction with FIGS. 1, 2 and 3 may be used to produce hollow-core optical fibers (HCF) of different cross-sections/geometries. FIGS. 4A and 4B depict examples of two HCFs that may be produced by the system and method described in present disclosure. The example cross-sections/geometries of the HCF depicted in FIGS. 4A and 4B should not be construed as limiting, and the system and method described in present disclosure may be used to produce HCF with different cross-sectional shapes and geometries.

FIG. 4A depicts a first example cross-sectional view of an anti-resonant hollow-core fiber (AR-HCF) 402 design in accordance with one or more embodiments of the present disclosure, produced by using the single-stage draw tower 100 or the multi-stage draw tower 200 described above in conjunction with FIGS. 1, 2 and 3. In some embodiments, the AR-HCF 402 may include one or more cladding structures 404 providing a hollow interior region 406. For example, FIG. 4A depicts the AR-HCF 402 with a single cladding structure 404 formed as a circular tube. In some embodiments, the AR-HCF 402 may further include multiple AR elements 408 distributed in the hollow interior region 406 provided by the cladding structures 404. As an illustration, FIG. 4A depicts a configuration with seven sets of nested AR elements 408, where each of the nested AR elements includes one AR element 408 within another AR element 408. In some embodiments, the AR-HCF 402 includes one or more support structures 410, which may position at least one AR element 408 within the AR-HCF 402. For example, at least one AR element 408 may be connected to at least one support structure 410. The support structures 410 may generally be formed as or be in contact with the cladding structures 404 and/or any of the AR elements 408.

The example geometry of the AR-HCF 402 shown in FIG. 4A may be produced by using the single-stage draw tower 100 or the multi-stage draw tower 200, and drawing the preform at a high draw tension of greater than 1,000 grams (preferably greater than 1,500 grams).

FIG. 4B depicts a second example cross-sectional view of the AR-HCF 402 design in accordance with one or more embodiments of the present disclosure, produced by using the single-stage draw tower 100 or the multi-stage draw tower 200 described above in conjunction with FIGS. 1, 2 and 3. FIG. 4B is substantially the same as FIG. 4A, except that a single “offset” second AR element 408b may be located within the interior region of a first AR element 408a. Stated another way, the second AR elements 408b are not symmetrically placed within the first AR elements 408a and are thus not centered on a radial line 412 from the center of the AR-HCF 402.

The example geometry of the AR-HCF 402 shown in FIG. 4B may be produced by using the single-stage draw tower 100 or the multi-stage draw tower 200, and drawing the preform at a high draw tension of greater than 1,000 grams (preferably greater than 1,500 grams).

The example cross-sectional structures of the AR-HCF 402 depicted in FIGS. 4A and 4B should not be construed as limiting. The cross-sectional structures of the AR-HCF 402 depicted in FIGS. 4A and 4B are just for illustrative purpose, and the AR-HCF 402 may have different cross-sectional structures, without departing from the scope of the present disclosure. Further example AR-HCF cross-sectional structures are depicted in the U.S. patent application Ser. No. 18/662,573, filed on May 13, 2024, which is incorporated by reference in its entirety in the present disclosure.

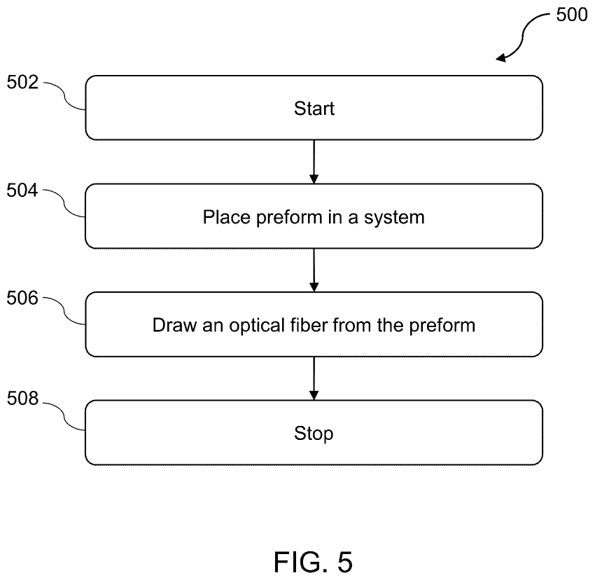

FIG. 5 is a flow diagram of a method 500 to fabricate an optical fiber in accordance with one or more embodiments of the present disclosure. Applicant notes that the embodiments and enabling technologies described previously herein in the context of the single-stage draw tower 100 and the multi-stage draw tower 200 should be interpreted to extend to the method 500. It is further noted, however, that the method 500 is not limited to the architecture of the single-stage draw tower 100 and the multi-stage draw tower 200.

The method 500 may start at step 502. At step 504, the method 500 may include placing a preform in a system. The system may be the single-stage draw tower 100 or the multi-stage draw tower 200. As described above, the preform may be placed on the preform feeder 104 or the preform feeder 204.

At step 506, the method 500 may include drawing the optical fiber at the desired diameter (and the desired draw tension) from the preform via the single-stage draw tower 100 or the multi-stage draw tower 200. The optical fiber may be a hollow-core optical fiber (HCF). As described above, the single-stage draw tower 100 may include a single stage at a highest vertical position, which may include the single draw furnace 202. The single-stage draw tower 100 may be configured to draw the optical fiber having the desired diameter in a single draw process. On the other hand, the multi-stage draw tower 200 may include a plurality of draw stages that may be configured to progressively reduce the diameter of the preform to draw the optical fiber at the desired diameter. The preform may be drawn at a high draw tension of greater than 1,000 grams (preferably greater than 1,500 grams), as described above in conjunction with FIGS. 1, 2 and 3.

The method 500 may end at step 508.

In particular embodiments, certain features described herein in the context of separate implementations may also be combined and implemented in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variations of a sub-combination.

While operations may be depicted in the drawings as occurring in a particular order, this should not be understood as requiring that such operations be performed in the particular order shown or in sequential order, or that all operations be performed. Further, the drawings may schematically depict one more example processes or methods in the form of a flow diagram or a sequence diagram. However, other operations that are not depicted may be incorporated in the example processes or methods that are schematically illustrated. For example, one or more additional operations may be performed before, after, simultaneously with, or between any of the illustrated operations. Moreover, one or more operations depicted in a diagram may be repeated, where appropriate. Additionally, operations depicted in a diagram may be performed in any suitable order. Furthermore, although particular components, devices, or systems are described herein as carrying out particular operations, any suitable combination of any suitable components, devices, or systems may be used to carry out any suitable operation or combination of operations. In certain circumstances, multitasking or parallel processing operations may be performed. Moreover, the separation of various system components in the implementations described herein should not be understood as requiring such separation in all implementations, and it should be understood that the described program components and systems may be integrated together in a single software product or packaged into multiple software products.

Various embodiments have been described in connection with the accompanying drawings. However, it should be understood that the figures may not necessarily be drawn to scale. As an example, distances or angles depicted in the figures are illustrative and may not necessarily bear an exact relationship to actual dimensions or layouts of the devices illustrated.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

The term “or” as used herein is to be interpreted as an inclusive or meaning any one or any combination, unless expressly indicated otherwise or indicated otherwise by context. Therefore, herein, the expression “A or B” means “A, B, or both A and B.” As another example, herein, “A, B or C” means at least one of the following: A; B; C; A and B; A and C; B and C; A, B and C. An exception to this definition will occur if a combination of elements, devices, steps, or operations is in some way inherently mutually exclusive.

As used herein, words of approximation such as, without limitation, “approximately, “substantially,” or “about” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as having the required characteristics or capabilities of the unmodified feature. In general, but subject to the preceding discussion, a numerical value herein that is modified by a word of approximation such as “approximately” may vary from the stated value by ±0.5%, ±1%, ±2%, ±3%, ±4%, ±5%, ±10%, ±12%, or ±15%. The term “substantially constant” refers to a value that varies by less than a particular amount over any suitable time interval. For example, a value that is substantially constant may vary by less than or equal to 20%, 10%, 1%, 0.5%, or 0.1% over a time interval of approximately 10⁴ s, 10³ s, 10² s, 10 s, 1 s, 100 ms, 10 ms, 1 ms, 100 μs, 10 μs, or 1 μs. The term “substantially constant” may be applied to any suitable value, such as for example, an optical power, a pulse repetition frequency, an electrical current, a wavelength, an optical or electrical frequency, or an optical or electrical phase.

As used herein, the terms “first,” “second,” “third,” etc. may be used as labels for nouns that they precede, and these terms may not necessarily imply a particular ordering (e.g., a particular spatial, temporal, or logical ordering). As an example, a system may be described as determining a “first result” and a “second result,” and the terms “first” and “second” may not necessarily imply that the first result is determined before the second result.

As used herein, the terms “based on” and “based at least in part on” may be used to describe or present one or more factors that affect a determination, and these terms may not exclude additional factors that may affect a determination. A determination may be based solely on those factors which are presented or may be based at least in part on those factors. The phrase “determine A based on B” indicates that B is a factor that affects the determination of A. In some instances, other factors may also contribute to the determination of A. In other instances, A may be determined based solely on B.

Although the foregoing embodiments in the present disclosure have been described in some detail for purposes of clarity of understanding, the invention is not limited to the details provided. There are many alternative ways of implementing the invention. The disclosed embodiments are illustrative and not restrictive.

What is claimed is:

1. A system comprising:
a draw furnace configured to heat a preform and draw an optical fiber from the preform, wherein:
the system is configured to draw the optical fiber at a desired draw tension, and
the desired draw tension is greater than 1,000 grams.

2. The system of claim 1, wherein the system is a single-stage draw tower.

3. The system of claim 1, wherein the optical fiber is a hollow-core fiber, and wherein the hollow-core fiber comprises a core and one or more anti-resonant elements.

4. The system of claim 1, wherein the desired draw tension is greater than 1,500 grams.

5. The system of claim 1 further comprising a pressure system configured to apply a pressure to the preform.

6. The system of claim 1 further comprising a puller configured to draw the optical fiber at a desired draw speed.

7. The system of claim 6 further comprising a monitoring system configured to monitor one or more parameters of the preform or the optical fiber during a draw process.

8. The system of claim 7, wherein the one or more parameters comprise a diameter, a temperature, a draw speed, a tension, or a geometry of the preform or the optical fiber.

9. The system of claim 8 further comprising a controller configured to:
obtain inputs from the monitoring system; and
control at least one of a furnace temperature associated with the draw furnace or the draw speed associated with the puller to maintain the desired draw tension based on the inputs.

10. The system of claim 8 further comprising a controller configured to:
obtain inputs from the monitoring system; and
control an operation of the puller to draw the optical fiber at a desired diameter based on the inputs.

11. A system comprising:
a plurality of draw furnaces associated with a plurality of draw stages, wherein:
the plurality of draw furnaces is configured to progressively decrease a diameter of a preform to form an optical fiber in a single draw process,
the system is configured to draw the optical fiber at a desired draw tension, and
the desired draw tension is greater than 1,000 grams.

12. The system of claim 11, wherein the system is a multi-stage draw tower, wherein the plurality of draw stages comprises a first draw stage at a highest vertical position, and successive draw stages below the highest vertical position.

13. The system of claim 12, wherein the system is configured to draw the optical fiber at the desired draw tension at the first draw stage.

14. The system of claim 12, wherein the system is configured to draw the optical fiber at the desired draw tension at the first draw stage and one or more successive draw stages.

15. The system of claim 12 further comprising a pressure system configured to apply a pressure to the preform prior to the first draw stage.

16. The system of claim 11, wherein the optical fiber is a hollow-core fiber, and wherein the hollow-core fiber comprises a core and one or more anti-resonant elements.

17. The system of claim 11, wherein the desired draw tension is greater than 1,500 grams.

18. The system of claim 11 further comprising one or more pullers configured to draw the optical fiber through the plurality of draw stages.

19. The system of claim 11 further comprising a monitoring system configured to monitor one or more parameters of the preform at each draw stage or one or more parameters of the optical fiber.

20. An optical fiber drawn in a system, wherein the optical fiber is a hollow-core fiber, wherein the system is configured to draw the optical fiber at a desired draw tension, and wherein the desired draw tension is greater than 1,000 grams.
